(19) United States
(12) Patent Application Publication
(10) Pub. No.: US 2022/0090939 A1
(43) Pub. Date: Mar. 24, 2022

(54) EHORIZON UPGRADER MODULE, MOVING OBJECTS AS EHORIZON EXTENSION, SENSOR DETECTED MAP DATA AS EHORIZON EXTENSION, AND OCCUPANCY GRID AS EHORIZON EXTENSION

(71) Applicant: VISTEON GLOBAL TECHNOLOGIES, INC., Van Buren Township, MI (US)

(72) Inventors: Martin Pfeifle, Seewald (DE); Hendrik Bock, Van Buren Township, MI (US); Mathias Otto, Pfinztal-Söllingen (DE); Markus Schaefer, Van Buren Township, MI (US); Sebastian Ammann, Van Buren Townshop, MI (US); Nikola Karamanov, Sofia (BG); Markus Mainberger, Van Buren Township, MI (US)

(73) Assignee: VISTEON GLOBAL TECHNOLOGIES, INC., Van Buren Township, MI (US)

(21) Appl. No.: 17/420,294

(22) PCT Filed: Jan. 6, 2020
(86) PCT No.: PCT/IB2020/050059

§ 371 Date: Jul. 1, 2021

Related U.S. Application Data
(60) Provisional application No. 62/788,598, filed on Jan. 4, 2019.

(51) Int. Cl. G01C 21/00; G01C 21/32

(52) U.S. Cl. CPC G01C 21/3841; G01C 21/3819; G01C 21/3822; G01C 21/32

(57) ABSTRACT

A method for providing vehicle information includes: receiving first vehicle data encoded according to a first protocol and corresponding to an environment external to a vehicle; receiving high definition mapping data corresponding to objects in the environment external to the vehicle; generating position information for objects indicated in the high definition mapping data by correlating locations of objects indicated by the high definition mapping data with objects in the environment external to the vehicle detected by at least one sensor; generating second vehicle data by correlating the high definition mapping data, the position information, and the first vehicle data; and encoding the second vehicle data according to a second protocol.

### CROSS REFERENCE TO RELATED APPLICATION

This PCT International Patent Application claims the benefit of U.S. Provisional Patent Application Ser. No. 62/788,598 filed Jan. 4, 2019, the entire disclosure of the application being considered part of the disclosure of this application and hereby incorporated by reference.

### FIELD

Various vehicle systems may benefit from the selection of suitable mapping systems. For example, various navigation and driving awareness or alerting systems may benefit from various electronic horizon enhancements.

### SUMMARY

An aspect of the disclosed embodiments includes a system for providing vehicle information. The system includes a processor and a memory. The memory includes instructions that, when executed by the processor, cause the processor to: receive first vehicle data encoded according to a first protocol and corresponding to an environment external to a vehicle; receive high definition mapping data corresponding to objects in the environment external to the vehicle; generate position information for objects indicated in the high definition mapping data by correlating locations of objects indicated by the high definition mapping data with objects in the environment external to the vehicle detected by at least one sensor; generate second vehicle data by correlating the high definition mapping data, the position information, and the first vehicle data; and encode the second vehicle data according to a second protocol.

Another aspect of the disclosed embodiments includes a method for providing vehicle information. The method includes: receiving first vehicle data encoded according to a first protocol and corresponding to an environment external to a vehicle; receiving high definition mapping data corresponding to objects in the environment external to the vehicle; generating position information for objects indicated in the high definition mapping data by correlating locations of objects indicated by the high definition mapping data with objects in the environment external to the vehicle detected by at least one sensor; generating second vehicle data by correlating the high definition mapping data, the position information, and the first vehicle data; and encoding the second vehicle data according to a second protocol.

Another aspect of the disclosed embodiments includes an apparatus that includes a processor and a memory. The memory includes instructions that, when executed by the processor, cause the processor to: receive standard defection vehicle data encoded according to a first protocol and corresponding to an environment external to a vehicle; receive high definition mapping data corresponding to objects in the environment external to the vehicle; generate position information for objects indicated in the high definition mapping data by correlating locations of objects indicated by the high definition mapping data with objects in the environment external to the vehicle detected by at least one sensor; generate high definition vehicle data by correlating the high definition mapping data, the position information, and the first vehicle data; determine a probable path for the vehicle using the high definition vehicle data; and encode the probable path according to a second protocol.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. The accompanying drawings are provided for purposes of illustration and not by way of limitation.

FIG. 1 illustrates a method according to certain embodiments.

FIG. 2 illustrates a system according to certain embodiments.

FIG. 3 illustrates a vehicle cockpit according to certain embodiments.

### DESCRIPTION

The following discussion is directed to various embodiments. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

Advanced Driver Assistance Systems Interface Specifications (ADASIS) is an international standardization initiative for the Electronic Horizon (ehorizon), which provides upcoming road data from a navigation or high definition (HD) map to the driver and the advanced driver assistance system (ADAS) system

Applications of ADASIS include driver assistance via human-machine interface (HMI), improved automatic cruise control (ACC) performance, advanced vehicle headlights, driver assistance via HMI with dynamic information, country road assistant, and highly automated driving.

Driver assistance via HMI can include display of upcoming road signs and economic driving recommendations, as well as safety and comfort indications. Improved ACC performance can include keeping a set speed independent of road slope, improved fuel consumption, and dynamic ACC for speed limits and curves.

Advanced vehicle headlights can prevent progressive high beam activation in urban areas and can provide predictive setting for steerable beams in curves. Driver assistance with dynamic information can include display of dynamic speed signs, warning for end of traffic jam, and hazard spot warning. Country road assistant can involve calculation of optimal speed on country roads, based on topography, curves, and speed limits. Highly automated driving can include a detailed lane model, provision of three-dimensional (3D) objects for localization, and navigation data standard (NDS) auto drive and ADASIS version 3 (v3) support.

The main differences between ADASIS v3 and ADASIS version (v2) are that v3 relies on HD map data for highly automated driving, can accommodate an Ethernet vehicle bus, may operate at a much higher resolution, and may have longer profile attributes, and more possible profile types.

For purposes such as ADAS alerts, moving objects around the car are typically represented in the car coordinate system.

The ehorizon upgrader module may get as input a simple ehorizon and creates out of this information together with a more detailed digital map, for example a high definition (HD) map, a more complex ehorizon. The simple ehorizon might be encoded in ADAS IS v2 and the complex ehorizon might be encoded in ADASIS v3.

Connecting an infotainment system electronic control unit (ECU) with an autonomous driving ECU may rely on more accurate map information. In between these two units an ehorizon upgrader module may run on a dedicated ECU, on the infotainment ECU, or on the autonomous driving ECU. The dedicated ECU may, for example, be a map ECU.

The simple ehorizon can be described as follows: it may include mainly link related data, such as data which is typically used by an infotainment system. This data may include, for example, link geometry, speed limits for links, and the like. The simple ehorizon may also contain data used by ADAS applications, for example the number of lanes, curvature, and slope values related to links. In the simple horizon, the positioning of the car can be rather coarse and related to link geometry and not to lane geometry. Positioning in a simple ehorizon does not take into account lane geometry information and landmark information. The simple Ehorizon might be encoded in ADASIS v2 format.

The complex Ehorizon can be described as follows: it may include, in addition to the content of the simple Ehorizon, information of lane geometry for lane boundaries and lane center line. In addition, the complex ehorizon may provide a more accurate position, such as lane level accuracy and a rather precise longitudinal/latitudinal positioning. The complex ehorizon may be encoded in ADAS IS v3 format.

The ehorizon upgrader can include three modules. A first module can be an ehorizon path matching module. This module can read the simple ehorizon and can match the simple ehorizon onto HD data. For example, the sequence of links from the simple ehorizon can be mapped to a sequence of links/lanes of an HD map.

The map matching module can derive a matching sequence of links/lanes from the HD map based on the sequence of SD links describing the most probable path of the simple ehorizon. The map databases between the SD and HD maps can differ and therefore the most probable paths may not be able to be matched via link-IDs as link IDs may be map database specific. The approaches described in, for example Agora C and Open_LR, can do the matching based on following information: road geometry, functional road classes of the roads, directional Information, and speed information.

These matching techniques and industry standards can be used for matching general trajectories or computed routes. A computed route can be regarded as one way of describing an ehorizon path but ehorizon paths can be more generic and can exist as well if no route has been calculated.

A simple but still powerful matching can be done based on geometrical information only. To do this, the average distance between the links can be computed, for example by using the average Euclidian distance as a basic measure expressing how well the links fit to each other.

The HD Positioning module can try to improve the car positioning information by aligning the localization objects from the HD map with the localization objects detected by the sensors.

Based on the rough GPS position, the HD Positioning module can retrieve all nearby localization objects from the map. Both map data and GPS position can be in a global coordinate system, such as WGS84.

The sensors, for example camera, LiDAR, radar, ultrasonic, or a fusion module, might provide a list of detected objects. The object position might be in the car coordinate system, namely relative to the car. By aligning the landmark information detected by the sensors with the global landmark information of the map, the HD positioning module can find an absolute position of the car. In this way, for example, the exact position of the car in the map can be determined.

A second module can be an HD positioning module. This module can improve the standard definition (SD) positioning by correlating sensor data with landmark information in the HD map.

A third module can be a complex ehorizon provider. This module can encode the most probable path in a certain format, such as ADASIS v3. To do so the module can use the map matched path, the HD position information and additional information from the HD map.

The complex ehorizon provider module can encode the most probable path in a certain format, for example ADASIS v3. To do so, the module can use the map matched path, the HD position information, and additional information from the HD map.

The module can express the most probable path provided by the simple ehorizon provider by using information from the HD map. The complex ehorizon provider can use as input the exact position and the mapped information of the ehorizon's most probable path, as well as access to the HD database. The encoding can then be done in a specific format, e.g. ADAS IS v3.

Certain embodiments therefore can relate to matching ehorizon paths from simple, link-based ehorizon paths which might be encoded in ADAS IS v2 to complex, lane-based ehorizon paths which might be encoded in ADASIS v3 by using Agora C, Open LR, and/or proprietary heuristics leveraging geometry and attributes of links and lanes.

Certain embodiments can relate to an ehorizon upgrader module that can include an ehorizon path matching module, an HD positioning module, and a complex ehorizon provider module.

The ehorizon upgrader module might be running on a dedicated ECU, which can be purely serving the purpose of providing a complex ehorizon based on a simple ehorizon. Alternatively, the ehorizon upgrader module can be running on an infotainment ECU or an ADAS ECU.

Although one purpose of the ehorizon upgrader module can be for upgrading simple ehorizon path information from an SD map to complex ehorizon path information from an HD map, there may be other use cases. For example, the module may used for upgrading an ehorizon from an old SD map to a new SD map, for example from an old map in ADASIS v2 to new map in ADASIS v2. Alternatively, the module may be used for upgrading an ehorizon from an old HD map to a new HD map, for example, from an old map in ADASIS v3 to a new map in ADASIS v3.

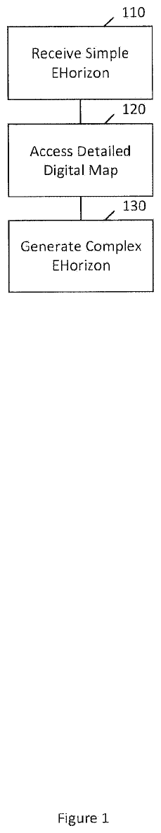

FIG. 1 illustrates a method according to certain embodiments. As shown in FIG. 1, a method can include receiving, at 110, a simple ehorizon. The method can also include, at 120, accessing a detailed digital map, such as an HD map. The method can further include, at 130, generating a more complex ehorizon.

As mentioned above, moving objects around a car (or other vehicle) have been represented in a car coordinate system. In certain embodiments, these moving objects can be represented in the ehorizon coordinate system. This use of the ehorizon coordinate system can help the function module to do path planning and decision making. The information can be provided as a proprietary and beneficial extension to the ADASIS standard.

Thus, for example, certain embodiments may align ehorizon information from maps with object information from sensors and may encode this information. This may be implemented as an extension to an existing standard.

Certain embodiments may relate to various fusion modules. For example, various traffic signal detection modules may provide output that may be fused by a traffic sign fusion module. Various lane detection modules may provide output that may be fused by a lane fusion module. Various object detection modules may provide output that may be fused by an object fusion module. Furthermore, various free-space detection modules may provide output that may be fused by a free-space fusion module.

Furthermore, a module for lane assignment for traffic signs may combine the output of a traffic sign fusion module and a lane fusion module. Similarly, a module for lane assignment for objects can combine the output for a lane fusion module an object fusion module. Furthermore, a verification module can combine outputs from an object fusion module and a free-space fusion module.

Various functional modules can rely on a shared environmental model. Data structures provided by the environmental model can include object representations containing position, velocity, uncertainty, and metadata. The data structures can also include lane representations containing geometry, uncertainty and metadata. The data structures can further include lane-to-object representations, traffic sign representations, and references to coordinate systems, such as a car coordinate system and/or ADASIS extensions. The functional modules supported can include automated emergency braking (AEB), lane departure protection (LDP), lane keeping assist system (LKAS), and adaptive cruise control (ACC).

The environmental model can contain dynamic objects such as cars, pedestrians, bikes, busses, and so on. The information of the environmental model can be expressed in the car coordinate system. Thus, the position of the objects can be expressed by the (x, y) offset with respect to the center of the back axis of the vehicle itself in which these calculations are being made (also known as the ego vehicle). The velocity vectors can also be represented in this coordinate system. Thus, a moving object can be represented by its position, velocity and acceleration values as well as the corresponding covariance matrices expressing the degree of uncertainty for this information.

By contrast, other ehorizon information, such as speed limits, can be expressed along an ehorizon path. This may be a two-dimensional indicator, where one dimension may represent a distance along a path, and another dimension may represent a distance from the center of the path. The ehorizon path might start at an intersection and follow the course of the road. Ehorizon information in this case is map related and typically static. Ego vehicle positional information can be part of the ehorizon message.

In certain embodiments, the information of other road users such as cars, bikes, pedestrians, and trucks can be expressed in the ehorizon coordinate system as well. An advantage of this approach can be that the planning module can more easily do decision making and trajectory planning as both map and sensor information can be provided in the same coordinate system. The moving objects can be sent out in the ehorizon coordinate system as an ehorizon extension.

By expressing position, velocity, heading and acceleration in the ehorizon coordinate system, a harmonized view of map data and information of other road users can be presented to planning, which may simplify decision making and trajectory planning.

Certain embodiments may relate to transformation of position, velocity, heading and acceleration information from the car coordinate system to the ehorizon coordinate system. Additionally or alternatively, certain embodiments may relate to transformation of position, velocity, heading and acceleration uncertainty information from the car coordinate system to the ehorizon coordinate system.

Additionally, certain embodiments may relate to expressing position, velocity, heading and acceleration and the corresponding uncertainty values in a mixture of car coordinate and ehorizon coordinate system. The center of this mixed coordinate system can be the ego-vehicle and the axis can be parallel to the corresponding axis of the ehorizon coordinate system.

Certain embodiments can encode the position, velocity, heading and acceleration information and the corresponding uncertainty values as user defined extension in the ADASIS v3 standard. The user defined extensions might contain objects encoded in the ehorizon coordinate system, the car coordinate system, or both coordinate systems.

Certain embodiments can provide static road information, such as traffic signs and lanes, as detected by the car sensors as an ehorizon extension.

Static objects such as lanes or traffic signs can be detected by sensors such as cameras. Their original representation can be in the sensor coordinate system, which may be relative to some point relative to the sensor. As the same information might be retrieved from other sensors as well, such as from a second camera or LiDAR, the information can be represented in the car coordinate system relative to a point on the detecting car, such as the center of the rear axis. A conversion can be made by applying a static transformation between the sensor and car coordinate systems. The origin of the car coordinate system can be, for example, defined by the center of the back axis of the car, as noted above.

Ehorizon information, such as speed limits, can be expressed along the ehorizon path. The dimension s can represent the distance along the path, in the longitudinal direction, and dimension d can represent the lateral distance from the center of the path. Ego vehicle positional information can be part of an ehorizon message.

Sensor detected lanes can be fused with map lane information. The fused representation can be in the car coordinate system and can be described in the car coordinate system by a vector and its corresponding covariance matrix. This information can then be expressed in the ehorizon coordinate system.

Certain embodiments can add the fused information from maps and sensors As ehorizon extension in the ehorizon coordinate system. The geometry of the lanes can be represented as a sequence of points in the ehorizon coordinate system and/or a vector and a starting point. The uncertainty in the representation can be expressed in ehorizon coordinate system. Other metadata of the lanes can also be expressed, which may be independent of the coordinate system, such as visibility range of the lanes by the sensor, lane marking type (for example, dash, solid, or the like), lane line color (for example, white, yellow, blue, or the like), and the sensor that detected the lane(s) and the timestamp of detection.

Traffic signs can be detected by the sensors of the car and may be represented in the car coordinate system. In addition, an ehorizon provider may provide traffic signs in the ehorizon coordinate system.

Certain embodiments may transform the position of the traffic signs detected by the sensors and represented in the car coordinate system or the sensor coordinate system to the ehorizon coordinate system and provide this as an additional extension, which may be a proprietary extension. This transformation can be a simple coordinate transformation. The detected type of the traffic signs by the sensor can also be part of this proprietary extension.

The position of the traffic sign may be more than just a single point but indeed an area described by a covariance matrix. This uncertainty may come, at least in part, from the uncertainty of the ego vehicle position and may be represented in the ehorizon coordinate system as well.

One way to accomplish such a transformation and representation may be to compute the sigma points of the uncertainty in the car coordinates system of the traffic sign covariance matrix and transform them to the ehorizon coordinate system. Then, the system can compute a covariance out of these transformed sigma points in the ehorizon coordinate system.

The traffic signs detected by the sensor can also be used by a localization module to do HD localization by aligning the traffic signs detected by the sensors with the information stored in the HD map.

Certain embodiments may involve adding the following extension to the ehorizon in the ehorizon coordinate system: a traffic sign value detected by the sensor, or a traffic sign value resulting from the fused sensor information, or a traffic sign value resulting from the fused sensor information and fused map information; a traffic sign position including covariance for the position, or a traffic sign position resulting from the fused sensor information including covariance for the position, or a traffic sign position resulting from the fused sensor information and fused map information including covariance for the position; and metadata telling which sensor provided the information including timestamps. The method of certain embodiments can include sending this information to a map ECU, localization module, and/or planning/decision making module, and/or HMI. The method of certain embodiments can further include encoding the information as an extension to the ADASIS standard. which may be a proprietary extension.

By expressing lane lines and traffic signs in the ehorizon coordinate system, a harmonized view of static data from map and static information detected by sensors can be presented to function and HMI modules. This use of the ehorizon coordinate system may simplify decision making, trajectory planning, and depiction of information to the user.

Certain embodiments relate to the transformation of lines and traffic signs provided by sensors or the fusion module from the car and/or sensor coordinate system to the ehorizon coordinate system.

Furthermore, certain embodiments relate to encoding line and traffic sign information and the corresponding uncertainty values as a user defined extension in the ADASIS standard.

Certain embodiments relate to an occupancy grid that is parallel to the ehorizon coordinate system. The ehorizon coordinate system, as explained above, is related to the road geometry.

In certain embodiments, all cells in the occupancy grid may contain relevant content. Other modules can use the occupancy grid information to have a harmonized view of map data and sensor data, for example for planning and decision making.

An occupancy grid can provide information about the presence of dynamic and static obstacles surrounding the vehicle. The grid can provide probabilities for occupied, free, or unknown grid cells at any point in time. The grid can be based on data from camera, LiDAR, ultrasonic, radar, and map. The map can be used in parking situations, stop-and-go situations, and highway situations.

An environmental model can provide data structures such as occupancy grids and vectorized data to a function submodule.

In certain embodiments, a two dimensional (2D) grid representing a 2D map in top view can provide information about the presence of dynamic and static obstacles surrounding a vehicle. One example use of such a grid can be for low speed traffic scenarios, such as parking or a traffic jam pilot.

In the example of a low speed use case, there may be a 2D circular buffer of a fixed size with a fixed resolution, which can be specified, for example, in terms of meters per cell. The vehicle may be in the center of the grid with an arbitrary ordientation. Different data and sensor sources can be fused using, for example, evidence theory. The evidence can be used to make an estimate for each cell that the cell is occupied, free, or unknown. The sum of the occupied probability, free probability, and unknown probability can equal 1.

Ultrasonic (US) sensors may be used as a sensor for a traffic jam pilot (TJP) scenario. The US sensors may have high accuracy in near range distance measurements of parallel surfaces, may be lightweight, low-cost, may work reasonably well in many environmental conditions. The US sensors can contribute data for the occupancy grid.

The grid can provide information about the presence of dynamic and static obstacles surrounding the vehicle, with probabilities for occupied, free, and unknown, at any point in time. The grid can serve as an input for stop and go operation in a TJP scenario. In such a near range scenario, the US sensors may be the primary useful sensors, as there may be a blind zone for other sensors.

The 2D top view map of the environment surrounding the vehicle can indicate the presence of obstacles and free space. Since the vehicle may be moving but memory is limited, the grid map can be defined in a restricted range around the vehicle.

There are at least two things that may affect the state and content of the grid: the passing of time and sensor measurements. Over time, the content of cells become less certain, thus the certainty that the cell is occupied or free degrades. Moreover, the vehicle itself can move, thus the vehicle's own position and orientation within the grid can change.

Additionally, whenever a new measurement comes from a sensor, certain cells may be updated by the measured data, which may change the state and content of the grid.

There are various ways a grid can be defined. For example, a grid can be a polar grid with the vehicle as the center of the grid, or a Cartesian grid. A Cartesian grid may be a grid with a Cartesian coordinate system. The grid may have an equal size in x and y directions and equal resolution in x and y directions, particularly at slow speeds, such as for parking or TJP scenarios. The overall grid shape may be square and the cells may be regular. The vehicle position may be in the center of the grid, and the vehicle orientation may be arbitrary.

A Cartesian grid can be implemented with a circular buffer. Moreover, there are efficient rasterization algorithms available for use with such features as rays, circles, filling of polygons, and so on. Furthermore, transformation between different Cartesian coordinate systems is mathematically simple.

Furthermore, in addition to the static and regular grid described above, various modifications are possible. For example, in certain embodiments there may be adapted resolution for parts of grid depending on distance to vehicle and/or adapted resolution for the whole grid depending vehicle velocity. Thus, in certain embodiments cells close to the vehicle may have a fine resolution, while cells farther from the vehicle may have a coarse resolution. In certain embodiments, the course resolution cells may be even multiples of the fine resolution cells.

In a local world coordinate system, the occupancy grid can be a regular grid with axes that are parallel to a world coordinate system. The car position might have an arbitrary heading inside this grid. The grid cells would only be aligned with the road geometry in this system when the road happens to align with the world coordinate system (for example, in cities where the roads are laid out in straight lines, north to south and east to west). Each cell might have a value indicating a probability that it is free or occupied. Additional information such as velocity vector or types might be stored as well in the grid cells. The car center and orientation may be independent of the grid.

In an ehorizon coordinate system, a grid can have an equal cell size in the (s, d) coordinate system rather than in an axis parallel (x, y) coordinate system. The grid cells can be limited to the road(s) or other drivable areas (such as a parking lot or garage) and can follow the course of the row. In certain embodiments, other areas such as sidewalks and road shoulders may also be included in the grid system. The grid cells can be sent out as ehorizon extensions as a simple two dimensional array in the (s, d) coordinate system.

The same information as in the local coordinate system grid can be stored in the grid cells of the ehorizon coordinate system. The car center and its orientation may be independent of the grid. Expressing the free space information as a two-dimensional grid in the ehorizon coordinate system may avoid wasting space, as all grid cells may cover relevant space. Furthermore, this expression may simplify processing of the free space information for subsequent function modules.

Creation of the occupancy grid for the ehorizon can be done in a variety of ways. For example, a grid can be formed in a local coordinate system and then a transformation can be applied, for example for each cell. Some cells in the local coordinate system may fall outside the range of the ehorizon coordinate system. Likewise, certain cells of the local coordinate system may map to the same ehorizon coordinate cell or may each map to multiple ehorizon cells.

There can be several heuristics applied to calculate the status of the grid cells in the ehorizon coordinate system. For instance, the status of could be defined by computing the percentage of intersection of each grid in the local coordinate system and weight accordingly the status of the grid cells.

Another way is to set the cells of the ehorizon coordinate system directly from the sensor data and to do fusion of the sensor information directly in the ehorizon grid. This may minimize error in estimation, as a sensor field of view may more naturally fit to the ehorizon grid than to the local world coordinate system.

By providing an occupancy grid that is parallel to the road geometry, function modules may be able to directly see which parts of the road are free and which occupied. All cells of the grid may be relevant, whereas in other Cartesian representations many cells might be off the road.

Certain embodiments involve computing and providing an occupancy grid for free space described by the following parameters: a starting point of an occupancy grid (s, d) and the corresponding index combination in the 2-dimensional array, the dimensions of the grid, and the resolution, such as 0.2 meters by 0.3 meters.

In certain embodiments, the content of each of the ehorizon grid cells can have the same kind of content as they would have in axis parallel grids, such as a probability value as to whether the cell is free, occupied or the status is unknown, and semantic values such as cell covers lane markings, cell is occupied by car, pedestrian, or the like. The ehorizon grid can be a dynamic grid also containing velocity vectors.

The ehorizon grid can be computed by carrying out a coordinate transformation from an axis parallel grid. In another alternative, the ehorizon grid can be directly filled with sensor data and sensor fusion can be carried out directly based on such a grid.

The grid may be stored in a fixed-size 2-dimensional array in memory and new cells may be added and/or deleted at corresponding positions of this array while the car is moving.

The ehorizon occupancy grid might be published as an ADASIS extension, for example, a proprietary extension.

An extended building footprint can refer to a specific layer of a navigation database system, which can be used for an advanced map display. A building footprint typically represents a building as a two-dimensional polygon. Some databases store extended building footprint information as a 2D polygon in WGS 84 coordinates and height information. Buildings can be composed of several building footprints.

Inside a database, for example inside the NDS database at the website of the NDS association, the footprints may be stored in tiles.

Tiles can be rectangular areas of a specific size, such as 2×2 km. Tiles typically cover many of the building footprints. Each tile covers a specific WGS 84 area. The coordinates for the building footprints can be stored relative to a center tile or lower-left corner tile. The reference tile can be called the tile anchor.

Based on these relative values and the absolute tile anchor coordinate it may be possible to retrieve the absolute coordinates for the polygons of the buildings. Sometimes, building footprints for cities are combined with very detailed representations of single famous buildings. For examples, in the building footprint tile there might be stored a reference to a detailed 3D Landmark building, such as the Eiffel Tower in Paris.

3D city models can be regarded as more a detailed representation of extended building footprints. Besides a more detailed geometry, which can be represented by a Triangulated Irregular network (TIN), the map can also contain textures. Sometimes these textures are real and sometimes they are artificial.

The data for 3D city models can be organized in tiles. Similar to building footprints, the 3D city model data might be cut at tile borders.

Navigation map rendering engines can read the tiles and render the tiles on a display. To do so, the map rendering engine can take current WGS 84 coordinates and can read the relevant tile(s) from the map and render them The map can be rendered in both a fixed-oriented way (for example, north-oriented) or a with a car centric view. The driver may be able to zoom in and out on the rendered image(s).

In certain embodiments, an ehorizon provider running on an in-vehicle infortainment (IVI) system can provide the building footprints and 3D city models as an extension, for example a proprietary extension.

On the cluster ECU, not only the moving objects and lanes detected by the ADAS ECU can be rendered but also the 3D city model coming from the IVI system. Other arrangements and sources of data are also possible. This information can be indicated in an image presented by a cluster ECU.

As described above, 3D building footprints and 3D landmarks can be stored in a map in WGS 84 coordinates. To transmit a building footprint as an ehorizon extension, the ehorizon provider may transform the sequence of shape points describing the building footprint/3D landmark from WGS 84 coordinates to (s, a) coordinates. The building can then be described by an ehorizon extension having a sequence of (s, d) points, a height value (or sequence of height values), and textures or colors if available. An ehorizon provider may do this conversion on the fly.

Alternatively, the geometry of a 3D landmark or building footprint can be transmitted, such that a single (s, d) point is transmitted as a reference point, and then the remainder of the dimensions are specified relative to the single point.

Building footprints in the map can be stored in a compact way, where the position of each shape point is described relative to a reference point. Thus, in certain embodiments, the coordinates of the reference point can be transformed to (s, d) coordinates, and the remaining points can be expressed in the same compact way in which they were stored. An additional parameter, alpha, can be used to express the rotational difference between the coordinates used by the building footprint in the map and the (s, d) coordinates at a given point. For example, if north and d are in the same direction, alpha may be zero, while if north and d are in opposite directions. alpha may be 180 degrees, or pi radians.

The ehorizon coordinates for a given building footprint may differ depending on the ehorizon path. For example, if a building is at an intersection, the ehorizon values may be different for a vehicle on one street as compared to a vehicle on a cross street. Thus, one option is to calculate the (s, d) values on the fly, rather than compiling the values offline for every possible path.

In typical cases, the building footprints may be outside the range of the grid used for parking and TJP calculations. Nevertheless, in certain cases a road or parking structure may lie beneath a building.

As mentioned above, building footprints and 3D city models can be organized in tiles. The coordinates of the building footprints can be represented with respect to the tile border. Rather than sending each building footprint as a single entity, certain embodiments can group building footprints into tiles. The starting point of the tile (s, d) can be transmitted and accompanied by a binary data structure in which each object is encoded relative to this tile border. The absolute ehorizon information can then be derived from the reference point and relative information.

As an optimization, the ehorizon may provide only a subset of the buildings in a tile, namely those buildings that are close to an ehorizon path. In a downtown area, a tile can contain thousands of building footprints, when tiles are sized 1 km×1 km. Thus, it may be useful for simplifying computation to reduce the number of transmitted building footprints.

For rendering purposes, the buildings close to the ehorizon may be relevant. These relevant buildings may be found by a spatial query that locates buildings within a given range from an identified path. This approach can be used with respect to sending single buildings as well as sending tiles.

In certain embodiments, the following content can be sent as an ehorizon extension: building footprints, extended building footprints, 3D landmarks, and 3D city models. In certain embodiments, single buildings can be sent as ehorizon extensions, where each coordinate can be encoded as an absolute (s, d) coordinate. Similarly, in certain embodiments, single buildings can be sent as ehorizon extensions where only one coordinate is encoded as an absolute (s, d) coordinate and the other coordinates are relative to this absolute coordinate. In addition, an angle can be sent describing the rotation of the ehorizon coordinate system at point (s, d) with respect to, for example, the WGS 84 system.

In certain embodiments, complete tiles can be sent as ehorizon extensions where the tile anchor can be sent in absolute (s, d) coordinates and the other points can be sent in relative coordinates.

In certain embodiments, a spatial filter can be applied for selecting only building footprints close to an ehorizon path. The resulting footprints can be sent as single entities or as part of a tile.

The above-described information can be encoded as extensions (for example, proprietary extensions) in the ADASIS v3 standard. The information might contain building footprint geometry, height information, texture information, and colors.

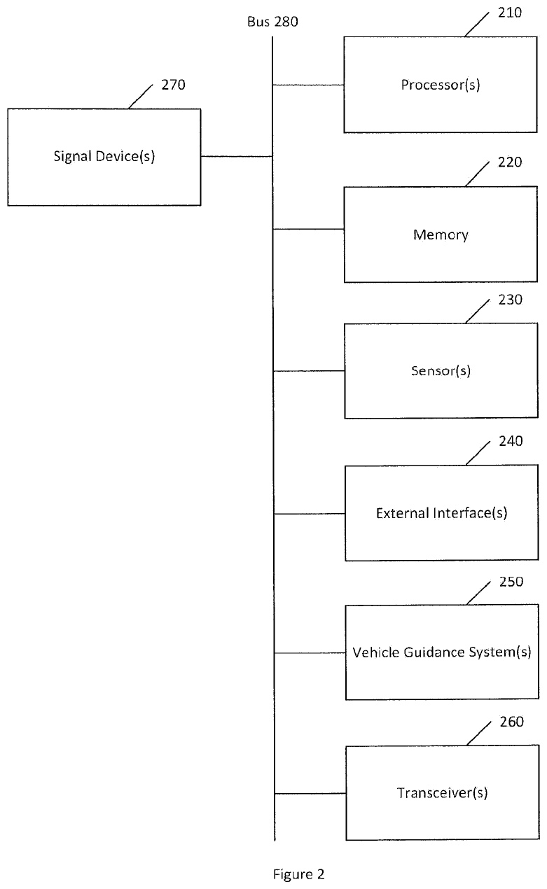

FIG. 2 illustrates a system according to certain embodiments. The system illustrated in FIG. 2 may be embodied in a vehicle or in one or more components of a vehicle. For example, certain embodiments may be implemented as an electronic control unit (ECU) of a vehicle.

The system can include one or more processors 210 and one or more memories 220. The processor 210 and memory 220 can be embodied on a same chip, on different chips, or otherwise separate or integrated with one another. The memory 220 can be a non-transitory computer-readable memory. The memory 220 can contain a set of computer instructions, such as a computer program. The computer instructions, when executed by the processor 210, can perform a process, such as the method shown in FIG. 1, or any of the other methods disclosed herein.

The processor 210 may be one or more computer chips including one or more processing cores. The processor 210 may be an application specific integrated circuit (ASIC) or a field programmable gate array (FPGA). The memory 220 can be a random access memory (RAM) or a read only memory (ROM). The memory 220 can be a magnetic medium, an optical medium, or any other medium.

The system can also include one or more sensors 230. The sensors 230 can include devices that monitor the position of the vehicle or surrounding vehicles. Devices can include, for example, global positioning system (GPS) or the like. The sensors 230 can include cameras (visible or infrared), LiDAR, ultrasonic sensors, or the like.

The system can also include one or more external interfaces 240. The external interface 240 can be a wired or wireless connection to a device that is not itself a component of the vehicle. Such devices may include, for example, smart phones, smart watches, personal digital assistants, smart pedometers, fitness wearable devices, smart medical devices, or any other portable or wearable electronics.

The system can also include one or more vehicle guidance systems 250. The vehicle guidance system 250 may include its own sensors, interfaces, and communication hardware. For example, the vehicle guidance system 250 may be configured to permit fully autonomous, semi-autonomous, and manual driving. The vehicle guidance system 250 may be able to assume steering control, throttle control, traction control, braking control, and other control from a human driver. The vehicle guidance system 250 may be configured to operate in conjunction with an advanced driver awareness system, which can have features such as automatic lighting, adaptive cruise control and collision avoidance, pedestrian crash avoidance mitigation (PCAM), satnav/traffic warnings, lane departure warnings, automatic lane centering, automatic braking, and blind-spot mitigation.

The system can further include one or more transceivers 260. The transceiver 260 can be a WiFi transceiver, a V2X transceiver, or any other kind of wireless transceiver, such as a satellite or cellular communications transceiver.

The system can further include signal devices 270. The signal device 270 may be configured to provide an audible warning (such as a siren or honking noise) or a visual warning (such as flashing or strobing lights). The signal device 270 may be provided by a vehicle's horn and/or headlights and taillights. Other signals are also permitted.

The signal device 270, transceiver 260, vehicle guidance system 250, external interface 240, sensor 230, memory 220, and processor 210 may be variously communicably connected, such as via a bus 280, as shown in FIG. 2. Other topologies are permitted. For example, the use of a Controller Area Network (CAN) is permitted.

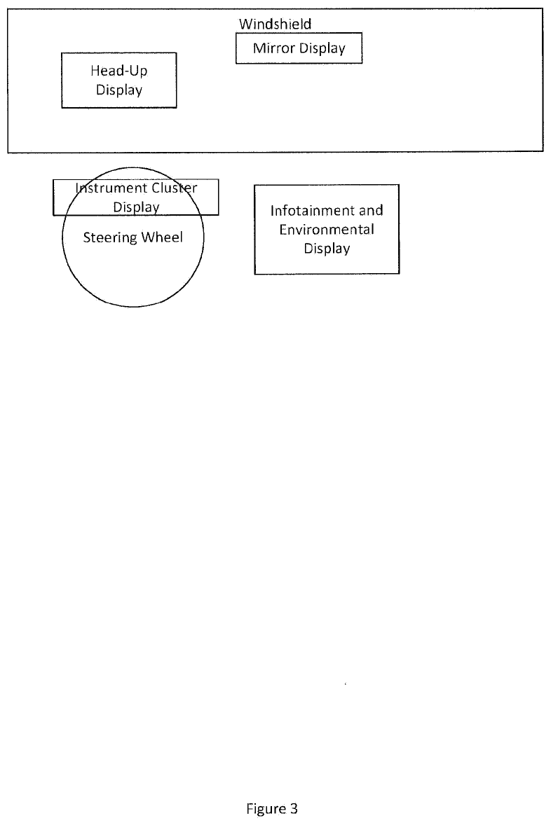

FIG. 3 illustrates a vehicle cockpit according to certain embodiments. As shown in FIG. 3, a vehicle cockpit, such as the cockpit of an automobile may have an instrument cluster display, an infotainment and environmental display, a head-up display, and a mirror display. The head-up display may be projected onto the windshield or presented from a screen between the steering wheel and the windshield. A mirror display can be provided as well, typically mounted to the windshield or ceiling of the vehicle.

The instrument cluster display may be made up of multiple screens. For a variety of reasons, such as historical configurations, the instrument cluster displays may be circular displays or may have rounded edges. The infotainment and environmental display may be located in a center console area. This may be one or more displays, and may allow for display of navigation, music information, radio station information, climate control information, and so on. Other displays are also permitted, for example, on or projected onto other surfaces of the vehicle.

In many of the preceding examples, there was discussion of ehorizon information being presented in a display. In certain embodiments, this information may be presented in a limited form in a head-up display and in a more complete form in an infotainment display. The use of this division of display may permit the system to provide the most crucial information to the vehicle driver without diverting the driver's eyes from the road, while providing a higher level of information to the driver in a large display format. Other displays could similarly be used, such as the instrument cluster display and the mirror display.

In some embodiments, a system for providing vehicle information includes a processor and a memory. The memory includes instructions that, when executed by the processor, cause the processor to: receive first vehicle data encoded according to a first protocol and corresponding to an environment external to a vehicle; receive high definition mapping data corresponding to objects in the environment external to the vehicle; generate position information for objects indicated in the high definition mapping data by correlating locations of objects indicated by the high definition mapping data with objects in the environment external to the vehicle detected by at least one sensor; generate second vehicle data by correlating the high definition mapping data, the position information, and the first vehicle data; and encode the second vehicle data according to a second protocol.

In some embodiments, the first protocol corresponds to advanced driver assistance systems interface specifications version 2 protocol. In some embodiments, the second protocol corresponds to advanced driver assistance systems interface specifications version 3 protocol. In some embodiments, the first vehicle data includes one or more of geometry data, speed limit data, lane data, road curvature data, and road slope data. In some embodiments, the second vehicle data includes the first vehicle data and one or more of object lane level accuracy data, longitudinal position data, latitudinal position data, and lane boundary data. in some embodiments, the first vehicle data includes standard definition mapping data. In some embodiments, the at least one sensor includes an image capturing device. In some embodiments, the at least one sensor includes one of a LIDAR device, a radar device, an ultrasonic device, and a fusion device.

In some embodiments. a method for providing vehicle information includes: receiving first vehicle data encoded according to a first protocol and corresponding to an environment external to a vehicle; receiving high definition mapping data corresponding to objects in the environment external to the vehicle; generating position information for objects indicated in the high definition mapping data by correlating locations of objects indicated by the high definition mapping data with objects in the environment external to the vehicle detected by at least one sensor; generating second vehicle data by correlating the high definition mapping data, the position information, and the first vehicle data; and encoding the second vehicle data according to a second protocol.

In some embodiments, the first protocol corresponds to advanced driver assistance systems interface specifications version 2 protocol. In some embodiments, the second protocol corresponds to advanced driver assistance systems interface specifications version 3 protocol, In some embodiments, the first vehicle data includes one or more of geometry data, speed limit data, lane data. road curvature data, and road slope data. In some embodiments, the second vehicle data includes the first vehicle data and one or more of object lane level accuracy data, longitudinal position data, latitudinal position data, and lane boundary data. In some embodiments, the first vehicle data includes standard definition mapping data. In some embodiments, the at least one sensor includes an image capturing device. In some embodiments, the at least one sensor includes one of a LIDAR device, a radar device, an ultrasonic device, and a fusion device.

In some embodiments, an apparatus includes a processor and a memory. The memory includes instructions that, when executed by the processor, cause the processor to: receive standard defection vehicle data encoded according to a first protocol and corresponding to an environment external to a vehicle; receive high definition mapping data corresponding to objects in the environment external to the vehicle; generate position information for objects indicated in the high definition mapping data by correlating locations of objects indicated by the high definition mapping data with objects in the environment external to the vehicle detected by at least one sensor; generate high definition vehicle data by correlating the high definition mapping data, the position information, and the first vehicle data; determine a probable path for the vehicle using the high definition vehicle data; and encode the probable path according to a second protocol.

In some embodiments, the first protocol corresponds to advanced driver assistance systems interface specifications version 2 protocol. In some embodiments, the second protocol corresponds to advanced driver assistance systems interface specifications version 3 protocol. In some embodiments, the instructions further cause the processor to store the probable path in a database.

The above discussion is meant to be illustrative of the principles and various embodiments of the present disclosure. Numerous variations and modifications will become apparent to those skilled in the art once the above disclosure is fully appreciated.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. The term “processor” should be understood as encompassing any of the foregoing hardware, either singly or in combination. The terms “signal” and “data” are used interchangeably.

For example, one or more embodiments can include any of the following: packaged functional hardware unit designed for use with other components, a set of instructions executable by a controller (e.g., a processor executing software or firmware), processing circuitry configured to perform a particular function, and a self-contained hardware or software component that interfaces with a larger system, an application specific integrated circuit (ASIC), a Field Programmable Gate Array (FPGA), a circuit, digital logic circuit, an analog circuit, a combination of discrete circuits, gates, and other types of hardware or combination thereof, and memory that stores instructions executable by a controller to implement a feature.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

We claim:

1. A system for providing vehicle information, the system comprising:
a processor; and
a memory including instructions that, when executed by the processor, cause the processor to:
receive first vehicle data encoded according to a first protocol and corresponding to an environment external to a vehicle;
receive high definition mapping data corresponding to objects in the environment external to the vehicle;
generate position information for objects indicated in the high definition mapping data by correlating locations of objects indicated by the high definition mapping data with objects in the environment external to the vehicle detected by at least one sensor;
generate second vehicle data by correlating the high definition mapping data, the position information, and the first vehicle data; and
encode the second vehicle data according to a second protocol.

2. The system of claim 1, wherein the first protocol corresponds to advanced driver assistance systems interface specifications version 2 protocol.

3. The system of claim 1, wherein the second protocol corresponds to advanced driver assistance systems interface specifications version 3 protocol.

4. The system of claim 1, wherein the first vehicle data includes one or more of geometry data, speed limit data, lane data, road curvature data, and road slope data.

5. The system of claim 1, wherein the second vehicle data includes the first vehicle data and one or more of object lane level accuracy data, longitudinal position data, latitudinal position data, and lane boundary data.

6. The system of claim 1, wherein the first vehicle data includes standard definition mapping data.

7. The system of claim 1, wherein the at least one sensor includes an image capturing device.

8. The system of claim 1, wherein the at least one sensor includes one of a LIDAR device, a radar device, an ultrasonic device, and a fusion device.

9. A method for providing vehicle information, the method comprising:
receiving first vehicle data encoded according to a first protocol and corresponding to an environment external to a vehicle;
receiving high definition mapping data corresponding to objects in the environment external to the vehicle;
generating position information for objects indicated in the high definition mapping data by correlating locations of objects indicated by the high definition mapping data with objects in the environment external to the vehicle detected by at least one sensor;
generating second vehicle data by correlating the high definition mapping data, the position information, and the first vehicle data; and
encoding the second vehicle data according to a second protocol.

10. The method of claim 9, wherein the first protocol corresponds to advanced driver assistance systems interface specifications version 2 protocol.

11. The method of claim 9, wherein the second protocol corresponds to advanced driver assistance systems interface specifications version 3 protocol.

12. The method of claim 9, wherein the first vehicle data includes one or more of geometry data, speed limit data, lane data, road curvature data, and road slope data.

13. The method of claim 9, wherein the second vehicle data includes the first vehicle data and one or more of object lane level accuracy data, longitudinal position data, latitudinal position data, and lane boundary data.

14. The method of claim 9, wherein the first vehicle data includes standard definition mapping data.

15. The method of claim 9, wherein the at least one sensor includes an image capturing device.

16. The method of claim 9, wherein the at least one sensor includes one of a LIDAR device, a radar device, an ultrasonic device, and a fusion device.

17. An apparatus comprising:
a processor; and
a memory including instructions that, when executed by the processor, cause the processor to:
receive standard defection vehicle data encoded according to a first protocol and corresponding to an environment external to a vehicle;
receive high definition mapping data corresponding to objects in the environment external to the vehicle;
generate position information for objects indicated in the high definition mapping data by correlating locations of objects indicated by the high definition mapping data with objects in the environment external to the vehicle detected by at least one sensor;
generate high definition vehicle data by correlating the high definition mapping data, the position information. and the first vehicle data;
determine a probable path for the vehicle using the high definition vehicle data; and
encode the probable path according to a second protocol.

18. The apparatus of claim 17, wherein the first protocol corresponds to advanced driver assistance systems interface specifications version 2 protocol.

19. The apparatus of claim 17, wherein the second protocol corresponds to advanced driver assistance systems interface specifications version 3 protocol.

20. The apparatus of claim 17, wherein the instructions further cause the processor to store the probable path in a database.
